(19) United States
(12) Patent Application Publication
(10) Pub. No.: US 2010/0163315 A1
(43) Pub. Date: Jul. 1, 2010

(54) BED MONITORING PAD

(76) Inventors: Rachel Dunford York, San Diego, CA (US); Steven Alfred Williams, Lantau Island NT (HK)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/606,043

(22) Filed: Oct. 26, 2009

Related U.S. Application Data
(60) Provisional application No. 61/197,186, filed on Oct. 25, 2008.

(51) Int. Cl. G01G 19/52

(52) U.S. Cl. 177/144

(57) ABSTRACT

A sensor pad is adapted to be positioned on a patient's bed as part of a monitoring system that provides a signal to a nurse or other caregiver when the patient exits the bed. The sensor pad is thinner and more flexible than existing pads to provide comfort to the user.

### REFERENCE TO PRIORITY DOCUMENT

This application claims priority of co-pending U.S. Provisional Patent Application Ser. No. 61/197,186, filed on Oct. 25, 2008. The disclosure of the Provisional Patent Application is hereby incorporated by reference in its entirety.

### BACKGROUND

The present disclosure relates to a sensor pad and in particular relates to an exit sensor pad for detecting when an individual exits a bed.

A serious problem encountered by operators of hospitals, nursing homes, retirement centers and other facilities that take care of bed patients is that of patients leaving their beds and subsequently tripping or falling. Patients that are heavily medicated or sedated are particularly susceptible to falls. For these reasons much consideration has been given to systems for monitoring patients and providing a warning that a patient is in the process of or has exited his or her bed.

One type of systems is a bed exit sensor pad system that includes a sensor pad positionable on a mattress of a bed. The sensor pad is communicatively coupled to a monitoring device, such as a nurse call system. When pressure on the sensor pad is removed, such as when the patient removes himself or herself from the bed, the sensor pad sends a notification to the monitoring device, which provides a notification to the nurse or caregiver that the patient has gotten off the bed.

Existing bed sensor pads are thick and cumbersome. The thickness of the pad can result in an uncomfortable feel for the patient when the patient is lying on the pad. The pads are cumbersome in that they tend to be difficult to fold, which makes storage difficult. In view of the foregoing, there is a need for an improved bed exit sensor pad.

### SUMMARY

Disclosed is a bed sensor pad that is thin and flexible. The thin and flexible nature of the bed sensor pad improves the comfort of the pad over existing pads. The thin and flexible nature also permits the pad to be easily folded thereby providing for efficiency in storing the pad.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a side perspective view of a patient monitoring system including a sensor pad.

FIG. 2 is a schematic view of an exemplary sensor pad in partial exploded state.

### DETAILED DESCRIPTION

Before the present subject matter is further described, it is to be understood that this subject matter described herein is not limited to particular embodiments described, as such may of course vary. It is also to be understood that the terminology used herein is for the purpose of describing particular embodiments only, and is not intended to be limiting. Unless defined otherwise, all technical terms used herein have the same meaning as commonly understood by one skilled in the art to which this subject matter belongs.

As will be apparent to those of skill in the art upon reading this disclosure, each of the individual embodiments described and illustrated herein has discrete components and features which may be readily separated from or combined with the features of any of the other several embodiments without departing from the scope of the subject matter described herein. Any recited method can be carried out in the order of events recited or in any other order which is logically possible.

A unique sensor pad is adapted to be positioned on a patient's bed as part of a monitoring system that provides a signal to a nurse or other caregiver when the patient exits the bed. The sensor pad is thinner and more flexible than existing pads to provide comfort to the user. The sensor pad uses hardened, high conductivity, low corrosion materials for improved and durable contact, printed directly on a soft inner surfaces of a pad Polyvinyl chloride (PVC) material. In an embodiment, the low corrosion material comprises silver halides. A screen print process may be used to produce a special pattern of conductive material which is baked onto the PVC with heat. The disclosed bed sensor pad sensor is thinner and softer to the touch than existing bed sensor pads. In addition, the bed sensor pad provides increased comfort for the user in that it virtually cannot be felt when slept or sat upon. The bed sensor pad also does not make disconcerting creaking noises as do existing bed sensor pads. Because the pad is soft and compliant, it is also foldable and may be folded smaller for packing and sending in a box through the post.

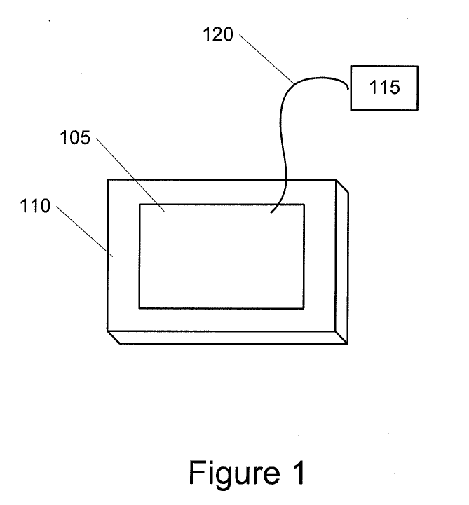

In an embodiment shown schematically in FIG. 1, a sensor pad 105 is positioned under or on top of a bed mattress 110. The sensor pad may be positioned on a variety of locations on the bed as long as the patient is on top of the pad when the patient lies or sits on the bed. Thus, the sensor pad 105 is preferably positioned in the area where the maximum weight of the patient is normally distributed and typically this is under the mattress 110 in the area under the hips of the patient. The sensor pad 105 provides an electrical signal to a monitor 115 when at least a substantial portion of the weight of the patient is removed. In this regard, the bed sensor pad 105 is communicatively coupled to the monitor 115 via a wired or wireless connection 120. By proper placement of the sensor pad, a signal can be given when a patient is in the process of exiting the bed that is, before the patient actually fully leaves the bed. For instance, when a patient moves to the edge of the bed the sensor pad if properly positioned, will provide a signal to the monitor 115. Thus, the sensor pad is positioned on the support (e.g., bed, chair) and is responsive to the weight of a patient. The sensor pad provides a switch signal when at least a substantial portion of the weight of the patient is removed from the sensor pad.

U.S. Pat. No. 7,474,224 describes an exemplary patient monitoring system with a magnetic disarming circuit. That application is incorporated herein by reference in its entirety.

It should be appreciated that the sensor pad is not limited to use with a bed or a bed mattress. The sensor pad can be used in combination with any item that a patient lays on or sits on, including a bed, chair, couch, etc. In this regard, the size and shape of the pad can vary to suit the item with which it is used. In an embodiment, the bed sensor pad is 30 inches by 4 inches in size. In an embodiment, the pad has a thickness of about ⅛ inch to ⅜ inch. In an embodiment, the pad is ¼ in thick.

Moreover, although described in the context of use with a nursing station, it should be appreciated that the sensor pad can be used in any situation where monitoring of a patient or individual is desired. For example, the bed sensor pad can be communicatively coupled to a Personal Emergency Alarm Systems (PERS) for on-site in assisted living accommodation to a nurses station or off-site alarm relay via the telephone network to family and/or friend caregivers and/or control centers, plus also with Nursecall Systems in hospitals, nursing homes and other assisted living accommodations. The bed sensor pad is coupled to the monitor via a wired or wireless connection.

Wired connections of the pad to bed monitors and nursecall bed head points and other devices may be made, for example, via various plugs (such as telephone plugs, jack plugs, etc.) according to the device connected. Wireless connections of the pad to bed monitors, bed head points, central monitors or other devices may use different coding systems for different monitoring devices. In the embodiment where a wired connection is used, a connection process is used to connect a printed circuit board to the printed layer at the neck of the sensor pad. This embodiment includes strain relief for the cable. The connection/link to the monitor or alarm device, PERS or Nursecall system may be wired or wireless. No separate inner layer is used in the pad and this results in a much softer, quieter performance.

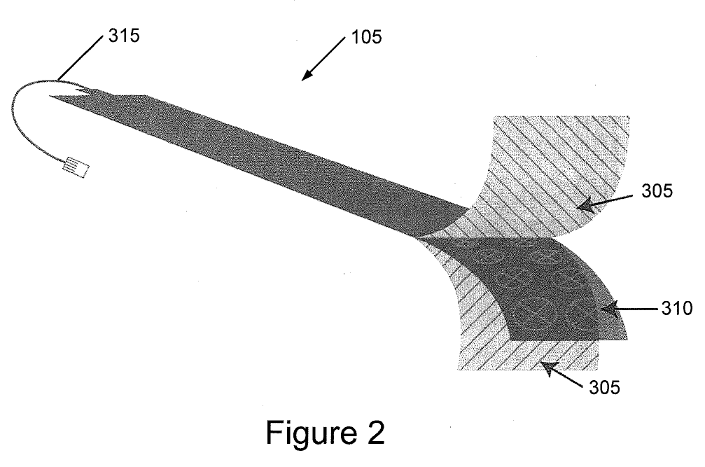

FIG. 2 shows a schematic view of the sensor pad in a partially exploded state with the layers peeled apart to illustrate the configuration of the layers. The sensor pad 105 includes multiple layers. In the fully assembled state, the layers are in a flat, juxtaposed relationship. For clarity of illustration, FIG. 2 shows a portion of the pad 105 with the layers peeled away from one another. The layers include a pair of outer layers 305 that are formed of a soft, flexible material that is easily foldable. In an embodiment, the outer layers 305 are made of soft plastic material that is flexible and pliant. The outer layers have an inner surface on which a conduction material is printed. The outer layers may be made of Polyvinyl chloride for example. The outer layers 305 include electrical conduction material that is printed directly on the inner surface of the layer. The conduction material may be a hardened, high conductivity, low corrosion material for improved and durable contact, printed directly on the soft inner surfaces of the outer layers 305. In an embodiment, the conduction material comprises silver halides. The sensor pad also includes at least one interior layer 310 positioned between the outer layers 305. The interior layer may be a sponge like material.

With reference still to FIG. 2, the sensor pad 105 includes a connection device 315 such as a jack plug or wireless connector, that permits the sensor pad to communicate with the monitor 115. As discussed, the connection device 315 can be wired or wireless.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Although embodiments of various methods and devices are described herein in detail with reference to certain versions, it should be appreciated that other versions, embodiments, methods of use, and combinations thereof are also possible. Therefore the spirit and scope of the appended claims should not be limited to the description of the embodiments contained herein.

What is claimed:

1. A support sensor pad for detecting when a patient exits a support, comprising:
a sensor pad positioned on the support and responsive to the weight of a patient and providing a switch signal when at least a substantial portion of the weight of the patient is removed from the sensor pad wherein the sensor pad comprises:
a first outer layer having an outer surface and an inner surface wherein an electrically conductive material is printed on the inner layer of the first outer layer;
a second outer layer having an outer surface and an inner surface wherein an electrically conductive material is printed on the inner layer of the second outer layer;
a middle layer positioned between the first and second outer layers;

2. A pad as in claim 1, wherein the support is a bed.

3. A pad as in claim 1, wherein the support is a chair.
